(19) United States
(12) Patent Application Publication
(10) Pub. No.: US 2026/0316270 A1
(43) Pub. Date: Oct. 15, 2026

(54) TRAJECTORY GENERATION FOR ROBOT PARAMETER IDENTIFICATION

(71) Applicant: Intrinsic Innovation LLC, Mountain View, CA (US)

(72) Inventors: Giovanni Sutanto, Sunnyvale, CA (US); Markus Giftthaler, Freising (DE); Bhaskara Mannar Marthi, Sunnyvale, CA (US)

(21) Appl. No.: 19/178,326

(22) Filed: Apr. 14, 2025

(51) Int. Cl. B25J 9/16

(52) U.S. Cl. CPC B25J 9/1666; B25J 9/1653

(57) ABSTRACT

Methods, systems, and apparatus, including computer programs encoded on a computer storage medium, for generating trajectories for robot parameter identification. According to one aspect, there is provided a method comprising: obtaining collision-free waypoints that satisfy a set of constraints, wherein each waypoint represents a joint configuration of a robot; generating a graph; selecting a plurality of waypoints that are reachable from a starting waypoint according to the graph; performing one or more pruning processes to generate a plurality of candidate subgraphs that each satisfy one or more linear-time solvability checks; computing a respective cost for each candidate subgraph; selecting a candidate subgraph based on the computed costs; and performing a path solving process on the selected candidate subgraph to generate a path to be traversed by the robot to obtain data for solving for robot parameters.

### BACKGROUND

This specification relates to robotics, and more particularly to planning robotic movements.

Robotic motion planning refers to scheduling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators. This scheduling of the physical movements of a robot can require knowledge of certain parameters of the robot.

In this specification, a workcell is the physical environment in which a robot will operate. Workcells have particular physical properties, e.g., physical dimensions, that impose constraints on how robots can move within the workcell. Thus, a manually programmed schedule for one workcell may be incompatible with a workcell having different robots, a different number of robots, or different physical dimensions.

### SUMMARY

This specification describes how a system can generate collision-free trajectories for a robot operating in an environment.

Parameter identification is the process of identifying parameters for modeling a dynamical system for control, such as a robot. In most cases, these parameters represent physical properties of the dynamical system, such as mass, inertia, and center-of-mass. The identification of the parameters of a dynamical system is needed by operators controlling the system in order to operate the dynamical system properly, e.g., with sufficient precision to perform a robotic task.

Empirical data is required as input to infer the parameter values. For this reason, a method for collecting the empirical data is needed. In parameter identification for a robot, the empirical data can be collected by pre-specifying a trajectory that the controlled robot has to traverse. The points along the pre-specified trajectory serve as data points from which the parameters of the robot can be inferred.

Legacy processes of specifying the trajectory of the robot (e.g., by means of “jogging” the robot and “teaching” the waypoints to be traversed) can be quite tedious, time-consuming, and require some expertise in the parameter identification process. For example, the robot trajectory must be designed in such a way that the collected data points are diverse (e.g., the least redundant as possible) and sufficiently provide the maximal amount of information for the parameter identification process to succeed.

The techniques described herein allow for automation of the process of pre-specifying the robot trajectory for the data collection of the parameter identification process. This can eliminate the need for a user to specify the trajectory themselves, thereby avoiding the issues described above.

In particular, the techniques described herein involve sampling a plurality of collision-free waypoints that represent joint configurations on a trajectory to be traversed by a robot. A graph representation of the plurality of collision-free waypoints is generated, and from this graph representation, a plurality of candidate subgraphs is generated that contain potential trajectories to be traversed by the robot. Advantageously, the plurality of candidate subgraphs is generated in such a way that each of the candidate subgraphs in the plurality of candidate subgraphs satisfies certain linear-time solvability checks. The satisfaction of the linear-time solvability checks helps to assure that the trajectory to be traversed by the robot is the least redundant trajectory possible that still allows for collection of a sufficient number of data points to infer parameters of the robot.

The cost of each of the plurality of candidate subgraphs is calculated based on a measure of the size of each candidate subgraph and a measure of how informative the waypoints of each candidate subgraph are for solving for the parameters of the robot. The candidate subgraph with the lowest cost is then selected to serve as the candidate subgraph from which the trajectory for the robot is generated. The trajectory for the robot is then generated by performing a path-solving process on the selected candidate subgraph.

Particular embodiments of the subject matter described in this specification can be implemented so as to realize one or more of the following advantages.

First, the techniques described herein allow for the generation of trajectories for robots from subgraphs that are likely to satisfy certain linear-time solvability checks. For example, according to the techniques described herein, the plurality of candidate subgraphs that are used to ultimately generate the trajectory for the robot are generated using pruning processes that help to assure that the candidate subgraphs will satisfy the linear-time solvability checks. Additionally, the candidate subgraph from which the final trajectory is to be generated is selected from the plurality of candidate subgraphs based in part on the likelihood that the candidate subgraph will satisfy the linear-time solvability checks.

It can be advantageous for the subgraph used to generate the trajectory for the robot to satisfy certain linear-time solvability checks because this can help to assure that the trajectory includes a smaller amount of redundancy while still being sufficiently informative to allow for the inference of robot parameters based on the traversal of the trajectory by the robot. This can be beneficial because redundancy can lead to waste of time and/or resources in having a robot traverse joint configurations that provide no new information regarding the parameters of the robot.

For example, conventional systems for generating trajectories for robots require the expense of excessive time and/or computational resources because trajectories with low redundancy and sufficient information for parameter identification have to be designed manually. The manual process of designing such trajectories can be tedious, time-consuming, and require expertise in the parameter identification process. While some conventional systems allow for automatic generation of such trajectories, these systems are only able to design such trajectories for robots in free space and cannot account for collision geometries.

Thus, the technological process of obtaining robot parameters through the generation of trajectories for robots is improved by the techniques described herein because they allow for the automatic generation of collision-free trajectories that reduces redundancy and enhances informativeness of the trajectories.

For example, it can be advantageous for the subgraph used to generate the trajectory for the robot to satisfy linear-time solvability checks that help to assure that the subgraph is solvable as a Traveling Salesperson Problem (TSP) because a graph that is solvable as a TSP corresponds to a trajectory that can be traversed such that each joint configuration in the trajectory (except for the starting joint configuration) is traversed by the robot exactly once. Therefore, a graph that is solvable as a TSP is less likely to be redundant.

By utilizing linear-time solvability checks to help assure that the subgraph used to generate the trajectory for the robot is solvable as a TSP, the techniques described herein avoid the need to run a TSP Dynamic Programming solver on large graphs. This is beneficial because the TSP Dynamic Programming solver has exponential time complexity and thus tends to be exponentially slow for large graphs.

Second, the techniques described herein allow for the generation of trajectories for robots that are as small as possible while still being likely to be informative for the purposes of inferring robot parameters. For example, the candidate subgraph from which the final trajectory is to be generated is selected from the plurality of candidate subgraphs based on criteria including the size of the subgraph and the likelihood that a trajectory generated from the subgraph will be informative for the purposes of inferring robot parameters. This can be beneficial because a minimal trajectory size helps to save time and resources by limiting the number of joint configurations to be traversed by a robot in order to identify its parameters.

Third, the techniques described herein allow for the automatic generation of collision-free trajectories for a robot. Legacy systems for generating trajectories for a robot are either not automatic or fail to account for collision geometries. The capacity to generate collision-free trajectories automatically is beneficial because it avoids the waste of time and/or resources involved in manually designing trajectories, while still helping to assure that the trajectories are collision-free.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system that can implement the robot path-generating techniques described in this specification.

FIG. 2 is an example process for generating a path to be traversed by a robot.

FIG. 3 is a diagram illustrating part of a process for generating a sample of collision-free waypoints based on a description of a robot and a workcell in which the robot operates.

FIG. 4 is an example result of running a BFS algorithm on a subgraph of collision-free waypoints in order to enumerate all possible pruned graph versions of the subgraph.

Like reference numbers and designations in the various drawings indicate like elements.

### DETAILED DESCRIPTION

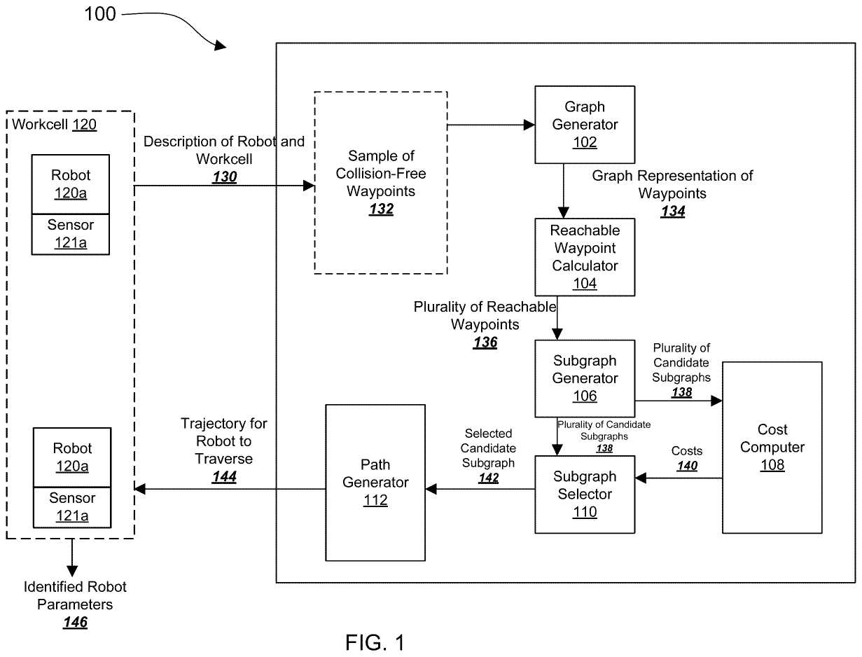

FIG. 1 is a diagram that illustrates an example system 100. The system 100 is an example of a system that can implement the robot path-generating techniques described in this specification.

The system 100 can be implemented as a computer program installed on one or more computers in one or more locations that are coupled to each other through any appropriate communications network, e.g., an intranet or the Internet, or combination of networks. The system 100 includes a graph generator 102, a reachable waypoint calculator 104, a subgraph generator 106, a cost computer 108, a subgraph selector 110, and a path generator 112.

In general, the system 100 provides commands to a robot, e.g., the robot 120a, in a workcell 120. The robot 120a can be used to lift or move items. The payload of the robot 120a can be the maximum that the robot 120a can lift or move. The commands provided by the system 100 indicate a trajectory, i.e., a path, to be traversed by the robot 120a in order to obtain data for solving for robot parameters of the robot 120a, such as the mass of the payload of the robot 120a and the center of mass of the payload of the robot 120a.

The robot 120a can have one or more joints. The one or more joints of the robot 120a can have one or more configurations. The configurations of the one or more joints can be collision-free. Collision-free joint configurations can include joint configurations of the robot 120a that do not result in the robot 120a colliding with objects in the workcell 120, and/or joint configurations of the robot 120a that do not result in the robot 120a being configured in such a way that is not feasible or practical (e.g., the robot 120a colliding with itself, having a configuration that causes wear on its one or more joints, or having a configuration that is otherwise undesirable).

In order to compute the commands, the system 100 receives a description 130 of the robot 120a and the workcell 120. The description 130 can be based on data collected by the sensor 121a. The sensor 121a can include one or more sensors. As illustrated in FIG. 1, the sensor 121a is coupled to the robot 120. However, the sensor 121a need not be coupled to the robot 120. The sensor 121a can be mounted on stationary or movable surfaces in the workcell 120.

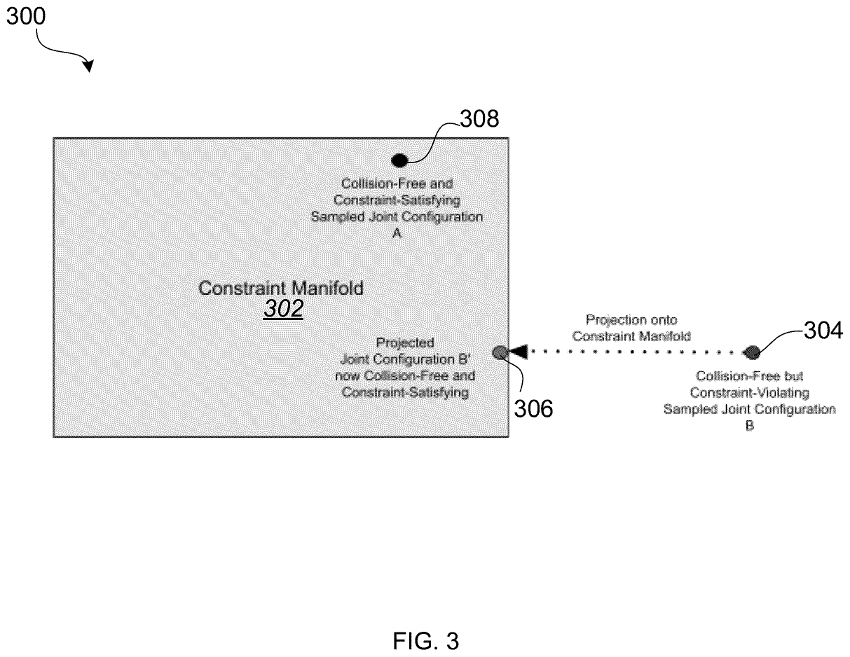

Based on the description 130, the system 100 generates a sample 132 of collision-free waypoints. The process by which the system 100 generates the sample 132 is described in further detail below with reference to FIG. 3. Each waypoint in the sample 132 represents a collision-free joint configuration of the robot 120a. The sample 132 can be based on a starting joint configuration of the robot. The sample 132 can include a waypoint that represents the starting joint configuration of the robot. The sample 132 can include any number of waypoints. As an example, the sample 132 can include 100 waypoints, where one of the waypoints represents the starting joint configuration of the robot and the other 99 waypoints are waypoints generated by the system 100 based on the starting joint configuration of the robot.

The sample of collision-free waypoints 132 is ingested by the graph generator 102. The graph generator 102 uses the sample of collision-free waypoints 132 to generate a graph representation 134 of the waypoints in the sample. The graph representation 134 can correspond to a graph of the waypoints, where each waypoint is a vertex of the graph. Two vertices of the graph can be connected by an edge if there is an interpolation between the joint configurations represented by the waypoints that are the vertices that does not result in either a collision or a violation of a set of constraints imposed on the trajectory to be determined for the robot.

The set of constraints can include any suitable constraints. For example, in some implementations, each joint configuration that the robot 120a assumes during an interpolation between two joint configurations can be mapped using a forward kinematics function into a six-dimensional (6D) cartesian coordinate space (of which three dimensions correspond to a three-dimensional (3D) position in the space, and three dimensions correspond to a three-dimensional (3D) orientation in the space). In such implementations, the set of constraints can include a constraint that is defined such that a joint configuration satisfies the constraint if its mapping into the 6D cartesian coordinate space has a 3D position that is within a specified bounding box. For example, the bounding box can be defined by a minimum and maximum value for the x-coordinate in the 3D space (e.g., x_min and x_max, respectively); a minimum and maximum value for the y-coordinate in the 3D space (e.g., y_min and y_max, respectively); and a minimum and maximum value for the z-coordinate in the 3D space (e.g., z_min and z_max, respectively). The 3D position of a mapping of a joint configuration into the 6D cartesian coordinate space can be defined by an x-coordinate of the 3D position, a y-coordinate of the 3D position, and a z-coordinate of the 3D position (e.g., x, y, and z, respectively). The joint configuration can then satisfy the constraint if x_min<=x<=x_max, y_min<=y<=y_max, and z_min<=z<=z_max.

In such implementations, the set of constraints can include a constraint such that a joint configuration satisfies the constraint if its mapping into the 6D cartesian coordinate space has a 3D orientation with a particular axis of the 3D orientation being within a specified angle of a specified 3D vector. If all joint configurations assumed by the robot 120a during an interpolation between two joint configurations represented by waypoints that are the vertices of the graph representation 134 satisfy the set of constraints, there is an edge between the vertices that represent the two joint configurations.

The graph representation 134 is a means of representing the above-described graph. The graph representation 134 can be an adjacency matrix constructed from a symmetric distance matrix. The symmetric distance matrix is a matrix whose entries represent a distance between two waypoints in the sample 132. The distance between two waypoints can be the L₂ norm of the difference between two vectors that represent the two waypoints, where each of the waypoints is represented as a vector of joint angular positions of the robot. The length of the vector representing a waypoint can be the number of the degrees of freedom of the robot.

For example, a vector representing a waypoint can be [0.0, 0.5, −0.2, 0.35, 0.89, −0.37]. This vector representation can indicate that, when the robot 120a has the joint configuration represented by the waypoint represented by the vector: 1) an angular position of a first joint or motor of the robot 120a is at 0.0 radians, 2) an angular position of a second joint or motor of the robot 120a is at 0.5 radians, 3) an angular position of a third joint or motor of the robot 120a is at −0.2 radians, 4) an angular position of a fourth joint or motor of the robot 120a is at 0.35 radians, 5) an angular position of a fifth joint or motor of the robot 120a is at 0.89 radians, and 6) an angular position of a sixth joint or motor of the robot 120a is at −0.37 radians. This vector can have a length of 6 because the robot 120a has six joints or motors, corresponding to 6 degrees of freedom.

In particular, each row of the symmetric distance matrix can correspond to a unique waypoint in the sample 132, and each column of the symmetric distance matrix can correspond to a unique waypoint in the sample 132. Then, the entry in the symmetric distance matrix at the i-th row and j-th column can represent the distance between the waypoint corresponding to the i-th row and the waypoint corresponding to the j-th column. In some implementations, the 0^{th} row of the symmetric distance matrix can correspond to the waypoint that represents the starting joint configuration of the robot. In some implementations, the 0^{th} column of the symmetric distance matrix can correspond to the waypoint that represents the starting joint configuration of the robot.

The correspondences of the rows and columns of the symmetric distance matrix can be such that the matrix is symmetric. For example, the first row of the symmetric distance matrix can correspond to the same waypoint that the first column in the symmetric distance matrix does; the second row in the symmetric distance matrix can correspond to the same waypoint that the second column in the symmetric distance matrix does; and so on for each of the rows and columns of the symmetric distance matrix. In this way, the entry in the i-th row and j-th column of the symmetric distance matrix will be equal to the entry in the j-th row and i-th column of the symmetric distance matrix.

In such configurations of the symmetric distance matrix, the diagonal entries of the matrix will all be equal to 0. This is because the diagonal entries represent the distance between a given waypoint and itself, which is always equal to 0.

In some implementations, the symmetric distance matrix can be configured such that the entry in the i-th row and j-th column of the matrix is equal to infinity if any interpolation between the waypoint corresponding to the i-th row and the waypoint corresponding to the j-th column results in either a collision or a violation of a set of constraints imposed on the trajectory to be determined for the robot. In software implementation of the symmetric distance matrix, the entries equal to infinity can be represented by a very large positive number.

An adjacency matrix can be constructed from the symmetric distance matrix. The adjacency matrix can be a square matrix with Boolean values (i.e., either “true” or “false”). The adjacency matrix can be constructed from the symmetric distance matrix by replacing any entry of the symmetric distance matrix equal to a non-zero finite value with a “true” Boolean value, and any entry of the adjacency matrix equal to zero or to infinity with a “false” Boolean value. In this way, any entry of the adjacency matrix with a “true” Boolean value indicates that there is an edge in the graph representation of the waypoints 134 between the waypoints corresponding to the column and row of the entry.

Below is shown an example symmetric distance matrix:

$$[ \begin{matrix}0 & 2 & ∞ & 7 & 5 \\ 2 & 0 & 1 & ∞ & ∞ \\ ∞ & 1 & 0 & 8 & 20 \\ 7 & ∞ & 8 & 0 & 11 \\ 5 & ∞ & 20 & 11 & 0\end{matrix} ]$$

Below is shown an example adjacency matrix that corresponds to the example symmetric distance matrix shown above:

$$[ \begin{matrix}false & true & false & true & true \\ true & false & true & false & false \\ false & true & false & true & true \\ true & false & true & false & true \\ true & false & true & true & false\end{matrix} ]$$

The graph representation 134 of the waypoints in the sample 132 is transmitted to the reachable waypoint calculator 104. The reachable waypoint calculator 104 selects a plurality of reachable waypoints 136 from the waypoints represented in the graph representation 134 that are reachable from the waypoint representing the starting joint configuration of the robot (“the starting waypoint”). A waypoint can be defined as being reachable from the starting waypoint if it is possible to reach the waypoint from the starting waypoint by traversing a number of edges of the graph equal to or less than a maximum number of edges.

The reachable waypoint calculator 104 can apply any appropriate search algorithm in order to select the plurality of reachable waypoints 136, for example, breadth-first search or depth-first search. For example, the plurality of reachable waypoints 136 can include waypoints traversable from the starting waypoint up to a particular depth level of a breadth-first search (BFS) algorithm. As a specific example, the plurality of reachable waypoints 136 can include waypoints traversable from the starting waypoint up to a depth level of 3 of the BFS algorithm.

The plurality of reachable waypoints 136 are transmitted to the subgraph generator 106. The subgraph generator 106 generates a plurality of candidate subgraphs 138 based on the received plurality of reachable waypoints 136.

The subgraph generator 106 can first form a subgraph of the plurality of reachable waypoints 136 by extracting a symmetric distance matrix describing the subgraph from the symmetric distance matrix representing all of the waypoints in the sample 132, on which the graph representation 134 is based. This can be beneficial because generating a symmetric distance matrix for a plurality of waypoints can consume a large amount of time and computing resources if done repetitively, as it requires a comparison to be made between each pair of waypoints in the plurality of waypoints. Therefore, by computing the pairwise distances once-and-only-once for graph representation 134, and only referring to the previously-computed sub-values when forming the subgraph's distance matrix, computation time can be saved. Forming the subgraph of the plurality of reachable waypoints 136 by extracting a symmetric distance matrix describing the subgraph from the symmetric distance matrix representing all of the waypoints in the sample 132 avoids the need to re-compute a new symmetric distance matrix for the plurality of reachable waypoints 136, thereby saving valuable time, computing resources, and computer storage space.

After forming the subgraph of the plurality of reachable waypoints 136, the subgraph generator 106 can perform one or more pruning processes on the subgraph. The one or more pruning processes reduce the size of the subgraph. Simultaneously, the one or more pruning processes help to assure that the subgraph contains a sufficient number of waypoints so that a trajectory generated based on the subgraph would provide information about robot parameters of the robot 120a if traversed by the robot 120a. Indeed, it is desirable for the size of the subgraph to be as small as possible given the current state of the process while still containing a sufficient number of waypoints because this can help to conserve time and resources spent on solving for the robot parameters, while still helping to assure that the subgraph provides enough information to allow the robot parameters to be determined using a trajectory based on the subgraph.

For example, the subgraph generator 106 can prune the subgraph of the plurality of reachable waypoints 136 by iteratively eliminating from the subgraph the least connected vertex (i.e., waypoint) of the subgraph. The least connected vertex of the subgraph can be defined as the vertex other than the vertex representing the starting joint configuration of the robot that has the smallest number of edges connecting it to other vertices of the subgraph. The subgraph generator 106 can, each time the least connected vertex of the subgraph is eliminated, additionally eliminate any remaining vertex with only one edge connecting it to other vertices.

The subgraph generator 106 can continue to iteratively eliminate vertices from the subgraph in this way until the remaining subgraph includes a number of waypoints equal to or below a maximum number of waypoints. The maximum number of waypoints can be any suitable number of waypoints. In some implementations, the maximum number of waypoints can be 15 waypoints.

This pruning process can be beneficial because it helps to assure that the resulting subgraph potentially satisfies one or more linear-time solvability checks. This in turn helps to assure that time and computer resources are not wasted in generating un-necessary trajectories for a robot based on the subgraph. For example, large subgraphs (e.g., subgraphs including waypoints larger than the maximum number of waypoints) may require the system to spend excessive time and/or computing resources in generating a trajectory for a robot based on the subgraph. Additionally, subgraphs that fail to satisfy the one or more linear-time solvability checks may induce un-necessary data redundancy, which can reduce efficiency in gathering information about robot parameters based on the traversal of the trajectory by the robot. Thus, computational efficiency in the process of generating trajectories for robots is improved through pruning processes that help to assure that the resulting subgraph satisfies the one or more linear-time solvability checks.

In some implementations, the one or more linear-time solvability checks are necessary conditions for the subgraph to be solvable as a Traveling Salesperson Problem (TSP). In such implementations, the one or more linear-time solvability checks can include the following:
1) If the number of vertices in the subgraph is greater than two, then every vertex in the subgraph must have at least two edges. If the number of vertices in the subgraph is equal to two, then every vertex in the subgraph must have at least one edge;
2) The number of connected components in the subgraph is one. A connected component of a graph or a subgraph is a set of vertices that are connected to each other by edges but are not connected to other vertices not included in the set. For example, a connected component of a graph or a subgraph can be defined as in Kleinberg, Jon and Tardos, Eva. “Algorithm Design”. Addison Wesley, 2006. The enumeration and counting of the connected components from the adjacency matrix of a subgraph can be done efficiently by using the Depth-First Search (DFS) algorithm which has a linear-time complexity; and
3) There is no cut vertex in the subgraph. A cut vertex of a graph or a subgraph is defined as a vertex of which the removal from the graph or subgraph increases the number of connected components included in the graph or subgraph. The extraction of any cut vertices from the adjacency matrix of the subgraph can be done efficiently also by using a DFS algorithm which has a linear time complexity.

In such implementations, the one or more pruning processes can help to assure that the resulting subgraph satisfies all three of the above conditions as necessary conditions for the subgraph to be solvable as a TSP. It can be beneficial for the resulting subgraph to satisfy these one or more linear-time solvability checks because, while it does not guarantee that the resulting subgraph is solvable as a TSP, it reduces the likelihood that the resulting subgraph will not be solvable as a TSP, e.g., because the resulting subgraph will not fail to satisfy any of the necessary conditions to be solvable as a TSP. It is beneficial for the resulting subgraph to be solvable as a TSP because subgraphs that are solvable as a TSP allow for the generation of trajectories for a robot that are able to be traversed in such a way that the robot assumes each joint configuration in the trajectory (except for the starting joint configuration) exactly once. This is desirable to reduce redundancy in the collection of data as the robot traverses the trajectory, since redundancy can waste time and resources.

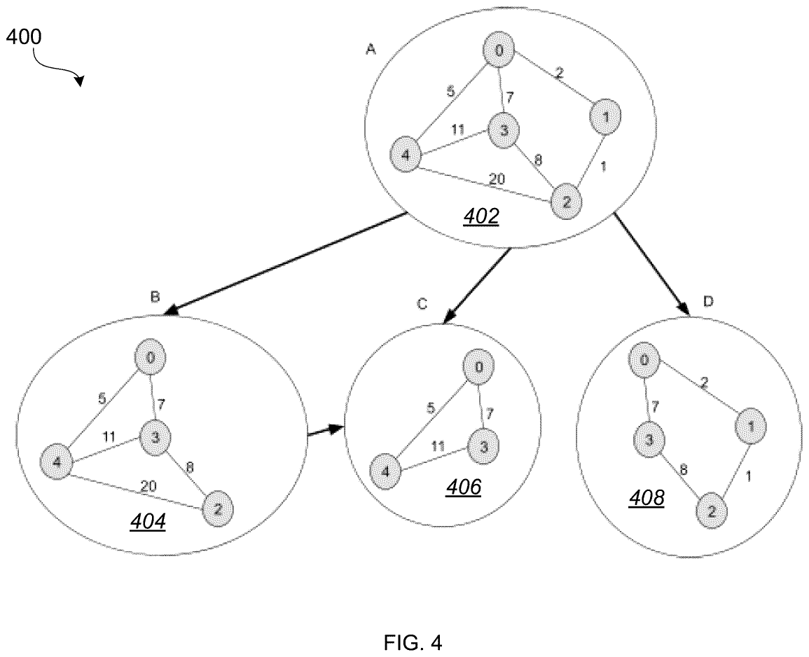

After performing the one or more pruning processes on the subgraph of the plurality of reachable waypoints 136, the subgraph generator 106 generates the plurality of candidate subgraphs 138 based on the subgraph resulting from the one or more pruning processes. The subgraph generator 106 can generate the plurality of candidate subgraphs 138 based on the subgraph resulting from the one or more pruning processes by enumerating all possible pruned graph versions of the subgraph resulting from the one or more pruning processes. The subgraph generator 106 can enumerate all possible pruned graph versions of the subgraph resulting from the one or more pruning processes in any suitable way. For example, the subgraph generator 106 can use a BFS algorithm to enumerate all possible pruned graph versions of the subgraph resulting from the one or more pruning processes. This can involve eliminating one or more vertices from the subgraph resulting from the one or more pruning processes. In particular, each candidate subgraph of the plurality of candidate subgraphs 138 can result from the elimination of one or more vertices from the subgraph resulting from the one or more pruning processes. The elimination of the one or more vertices from the subgraph resulting from the one or more pruning processes can be performed using the same process described above (e.g., eliminating the least connected vertex followed by eliminating any remaining vertex with only one edge connecting it to other vertices). The generation of the plurality of candidate subgraphs 138 based on the subgraph resulting from the one or more pruning processes using a BFS algorithm is described in further detail below with reference to FIG. 4.

The plurality of candidate subgraphs 138 is transmitted from the subgraph generator 106 to each of the cost computer 108 and the subgraph selector 110. The cost computer 108 computes a respective cost for each candidate subgraph of the plurality of candidate subgraphs 138 and then transmits the computed costs 140 to the subgraph selector 110. The cost for each candidate subgraph can be based on a measure of how informative the waypoints of the candidate subgraph are for solving for a plurality of robot parameters of the robot. In other words, the cost for each candidate subgraph can indicate the extent to which the traversal by a robot, such as the robot 120a, of a trajectory including the points represented by the waypoints included in the candidate subgraph would provide relevant information about the robot parameters 146 of the robot 120a.

In some implementations, the cost for each candidate subgraph can be based on the difference between the size of the candidate subgraph and a minimum graph size. The size of the candidate subgraph can be the number of waypoints or vertices included in the candidate subgraph. The minimum graph size can represent an allowed minimum size of the candidate subgraph and can be any suitable number. In some implementations, the minimum graph size can be equal to the number of unknowns to be identified in solving for the robot parameters of the robot 120a. For example, if the robot parameters to be solved for include the mass of the robot 120a and the center of mass of the robot 120a, there are four unknowns to be identified in solving for the robot parameters (mass is a scalar quantity and center of mass is a vector with three components). Thus, the minimum graph size in this example can be equal to four.

Allowing only candidate subgraphs that are at least a minimum size can be beneficial because trajectories that include a number of points less than the number of unknowns to be identified in solving for the robot parameters are unlikely to provide sufficient information to solve for the robot parameters. For example, if the robot parameters to be solved for are the mass of the robot and the center of mass of the robot, there are four unknowns to be identified. If a candidate subgraph has fewer than four waypoints, a robot traversing the trajectory including the points represented by the waypoints included in the subgraph would reach fewer than four points in the course of traversing the trajectory. This means that fewer than four data points are available to solve for four unknowns, which can be mathematically challenging.

Thus, it can be beneficial to allow only candidate subgraphs that are at least a minimum size in order to avoid wasting time and computing resources in processing candidate subgraphs that are unlikely to be useful in solving for the desired robot parameters. For this reason, in some implementations, the cost computer 108 can assign candidate subgraphs of the plurality of candidate subgraphs 138 with a size less than the allowed minimum size a cost of infinity. This ensures that, when the subgraph selector 110 selects a candidate subgraph with a minimum cost as described below, the subgraph selector 110 will not select a candidate subgraph that has a size smaller than the minimum graph size.

In some implementations, the cost for each candidate subgraph can be based on a condition number of a regressor matrix derived from the waypoints of the candidate subgraph. In particular, the cost calculator 108 can, for each candidate subgraph, construct a regressor matrix based on the candidate subgraph that can be used in a regression model that can be used to solve for the robot parameters. The cost calculator 108 can then determine the condition number of the regressor matrix, where the condition number is the ratio of the largest singular value of the regressor matrix to the smallest singular value of the regressor matrix. A singular value of the regressor matrix is the square root of a non-negative eigenvalue of the product of the regressor matrix and the adjoint of the regressor matrix. The condition number of the regressor matrix can represent a measure of how informative the waypoints of the candidate subgraph on which the regressor matrix is based are for solving for a plurality of robot parameters of the robot. In some implementations, the cost for each candidate subgraph can be based on the logarithm of the condition number.

In some implementations, the cost for each candidate subgraph can be based on both the difference between the size of candidate subgraph and a minimum graph size, and the condition number of a regressor matrix derived from the waypoints of the candidate subgraph. In some implementations, the cost for each candidate subgraph can be a linear combination of the difference between the size of candidate subgraph and a minimum graph size, and the logarithm of the condition number of a regressor matrix derived from the waypoints of the candidate subgraph. For example, the cost for a given candidate subgraph can be computed according to the following equation (1):

Cₜₒₜₐₗ=C_{size}+C_{condition_number} (1)
where Cₜₒₜₐₗ represents the total computed cost for the candidate subgraph, C_{size} is given by equation (2) below and C_{condition_number} is given by equation (3) below:

If (size(graph)≥min_{size(graph)}):C_{size}=size(graph)−min_{size(graph)} Otherwise: C_{size}=∞ (2)

C_{condition_number}=log(condition_number(regressor_matrix(graph))) (3)

The subgraph selector 110 receives the plurality of candidate subgraphs 138 from the subgraph generator 106 and the costs 140 from the cost computer 108. Using the plurality of candidate subgraphs 138 and the costs 140, the subgraph selector 110 selects a candidate subgraph 142 of the plurality of candidate subgraphs 138.

In order to select a candidate subgraph, the subgraph selector 110 can first sort the plurality of candidate subgraphs 138. In some implementations, the subgraph selector 110 can sort the plurality of candidate subgraphs 138 in increasing order of the cost of each candidate subgraph as computed by the cost computer 108. The plurality of candidate subgraphs 138 can be sorted according to cost in any suitable way. For example, a priority queue data structure can be used to sort the plurality of candidate subgraphs 138 according to cost. In particular, each candidate subgraph of the plurality of candidate subgraphs 138 can be stored with an associated priority, where the associated priority of the candidate subgraph is based on the cost computed for the candidate subgraph.

After sorting the plurality of candidate subgraphs 138, the subgraph selector 110 can select the candidate subgraph with the minimum cost relative to the costs of all of the plurality of candidate subgraphs 138. In implementations in which the cost for each candidate subgraph is defined to be Cₜₒₜₐₗ defined in equation (1) above, the candidate subgraph with the minimum cost relative to the costs of all of the plurality of candidate subgraphs 138 can be the candidate subgraph with the lowest value for Cₜₒₜₐₗ. In implementations in which the subgraph selector 110 uses a priority queue data structure to sort the plurality of candidate subgraphs 138, the subgraph selector 110 can select the candidate subgraph by extracting the minimum component of the priority queue. The minimum component of the priority queue can be the candidate subgraph with the minimum cost.

The subgraph selector 110 transmits the selected candidate subgraph 142 to the path generator 112. The path generator 112 performs a path solving process on the selected candidate subgraph 142 to generate a path to be traversed by the robot 120a in order to obtain data for solving for the robot parameters. The path generated by the path solving process can be a sequence of waypoints of the selected candidate subgraph 142 that meets one or more conditions. The one or more conditions can include a condition that, if the robot 120a assumes the sequence of joint configurations represented by the sequence of waypoints, the robot 120a will assume each joint configuration represented by the waypoints of the selected candidate subgraph 142 exactly once. It can be beneficial for the path to meet this condition because this helps to assure that the time taken for the robot 120a to traverse the path is minimized and that repetitive data points are not collected. For example, if the robot 120a assumes a joint configuration more than once while traversing the path, any subsequent instances (i.e., beyond the first instance) in which it assumes the joint configuration do not provide extra data for solving for the robot parameters and thus can waste time and resources.

In implementations in which the one or more conditions include the condition that the robot 120a will assume each joint configuration represented by the waypoints of the selected candidate subgraph 142 exactly once, the path generator 112 can generate the path using an algorithm for generating a path that meets the condition. For example, the path generator 112 can use any suitable algorithm for solving the Traveling Salesperson Problem (TSP). In some implementations, the path generator can use a TSP Dynamic Programming solver to generate the path.

In implementations in which the one or more conditions include the condition that the robot 120a will assume each joint configuration represented by the waypoints of the selected candidate subgraph 142 exactly once, the path generator 112 can generate the path by first applying the TSP Dynamic Programming solver to the selected candidate subgraph 142. If this results in the generation of a path that satisfies the condition, then the path generated by applying the TSP Dynamic Programming solver to the selected candidate subgraph 142 is the path generated by the path generator 112. If this does not result in the generation of a path that satisfies the condition (e.g., there is no path over the selected candidate subgraph 142 that satisfies the condition or there is no solution to the TSP for the selected candidate subgraph 142), the subgraph selector 110 can select a second selected candidate subgraph on which the path generator 112 can base the generated path. The subgraph selector 110 can select the second selected candidate subgraph to be the candidate subgraph with the lowest cost that is not the candidate subgraph that was already selected (i.e., that is not the selected candidate subgraph 142). For example, the subgraph selector 110 can extract the minimum component of the priority queue that is not the candidate subgraph that was already selected.

The path generator 112 can then apply the TSP Dynamic Programming solver to the second selected candidate subgraph and determine whether this results in the generation of a path that satisfies the condition. If it does, the path generated by applying the TSP Dynamic Programming solver to the second selected candidate subgraph is the path generated by the path generator 112; if it does not, the subgraph selector 110 can select a third selected candidate subgraph in the same way that the second selected candidate subgraph was selected. This process can be performed repeatedly until the application of the TSP Dynamic Programming solver to a selected candidate subgraph results in the generation of a path that satisfies the condition. The generated path can then be the path generated by the path generator 112.

The process described above for generating a path to be traversed by the robot in order to obtain data for solving for the plurality of robot parameters can be beneficial because it facilitates faster processing by better assuring that the TSP Dynamic Programming solver is applied to subgraphs of smaller sizes. The application of the TSP Dynamic Programming solver to large subgraphs tends to be slow due to the exponential time complexity of the solver. In this way, the application of the TSP Dynamic Programming solver to large subgraphs can use up valuable computing resources. However, in the process described above, the TSP Dynamic Programming solver is initially applied to the candidate subgraphs of the plurality of candidate subgraphs 138 that are smallest in size. The TSP Dynamic Programming solver is only applied to candidate subgraphs of larger sizes if its application to the candidate subgraphs of smaller sizes does not result in the generation of a path that satisfies the condition.

The path thus generated by the path generator 112 can represent a trajectory 144 for the robot 120a to traverse for a parameter identification data collection process. The trajectory 144 can be communicated to the robot 120a. This communication can cause the robot 120a to traverse the trajectory 144. This allows for the identification of the identified robot parameters 146. For example, as the robot 120a traverses the trajectory 144, measurements of various features of the robot 120a can be made and these measurements can be used to calculate the identified robot parameters 146. As another example, as the robot 120a traverses the trajectory 144, observations of the robot 120a can be made and these observations can be used to determine the identified robot parameters 146. The identified robot parameters 146 can be determined based on the trajectory 144 using any suitable techniques.

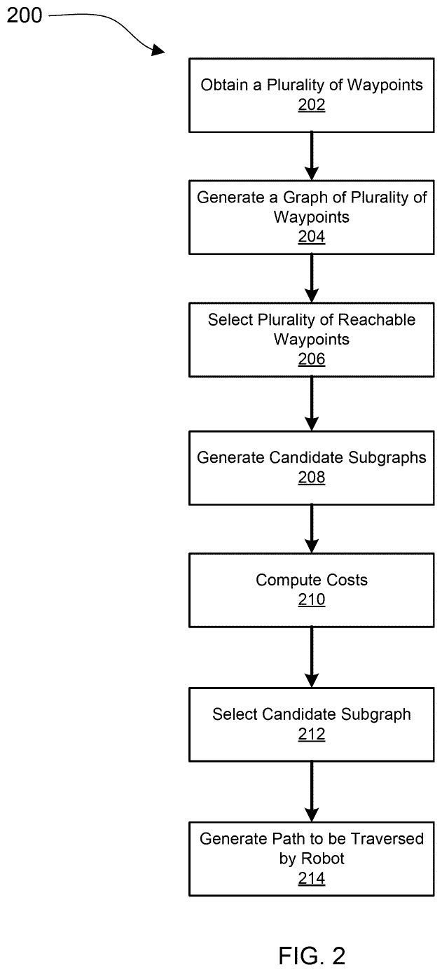

FIG. 2 is an example process 200 for generating a path to be traversed by a robot. For convenience, the process 200 will be described as being performed by a system of one or more computers located in one or more locations. For example, a system that can implement the robot path-generating techniques described in this specification, e.g., the system 100 of FIG. 1, appropriately programmed in accordance with this specification, can perform the process 200.

The system obtains a plurality of waypoints (step 202). Each waypoint in the plurality of waypoints represents a joint configuration of a robot. In particular, each waypoint in the plurality of waypoints represents a joint configuration of the robot that is both collision-free and satisfies all constraints included in a set of constraints. The one or more constraints can be determined by a user of the system. The one or more constraints can be based on constraints of an environment in which the robot operates and/or physical constraints of the robot. The system can obtain the plurality of waypoints through a sampling process, e.g., the process 300 described with reference to FIG. 3 below.

The system generates a graph of the plurality of waypoints (step 204). The graph includes vertices connected by edges. Each vertex represents a waypoint and each edge represents the existence of an interpolation between the waypoints represented by the vertices that it connects, that are both collision-free and satisfy all constraints in the set of constraints.

In some implementations, the graph of the plurality of waypoints can be represented by an adjacency matrix constructed from a symmetric distance matrix, as described in further detail above with reference to FIG. 1.

The system selects a plurality of reachable waypoints (step 206). The plurality of reachable waypoints is selected from the waypoints represented by the graph of the plurality of waypoints. The plurality of reachable waypoints is a set of waypoints that is reachable from a waypoint in the plurality of waypoints that represents a starting joint configuration of the robot. A first waypoint can be defined as being reachable from a second waypoint if it is possible to reach the second waypoint from the first waypoint by traversing a number of edges of the graph equal to or less than a maximum number of edges. In some implementations, the system applies a BFS algorithm to select the plurality of reachable waypoints.

The system generates candidate subgraphs (step 208). The system generates candidate subgraphs by performing one or more pruning processes on the plurality of reachable waypoints. In some implementations, the one or more pruning processes can help to assure that each of the candidate subgraphs satisfies one or more linear-time solvability checks. The one or more pruning processes are described in further detail above with reference to FIG. 1.

The system computes a cost for each candidate subgraph (step 210). The cost for each candidate subgraph is based on a measure of how informative the waypoints of the candidate subgraph are for solving for a plurality of robot parameters of the robot. In some implementations, the cost for each candidate subgraph is based on the difference between the size of the candidate subgraph and a minimum graph size, as described above with reference to FIG. 1. In some implementations, the cost for each candidate subgraph is based on a condition number of a regressor matrix derived from the waypoints of the candidate subgraph, as described above with reference to FIG. 1.

The system selects a candidate subgraph (step 212). The system selects the candidate subgraph based on the cost computed for each candidate subgraph. In particular, the system can select the candidate subgraph that has the minimum cost. In some implementations, the system selects the candidate subgraph using a priority queue data structure, as described above with reference to FIG. 1.

The system generates a path to be traversed by the robot (step 214). The system generates the path to be traversed by the robot based on the selected candidate subgraph. In some implementations, the system generates the path to be traversed by the robot by performing a path solving process on the selected candidate subgraph, as described above with reference to FIG. 1.

FIG. 3 is a diagram illustrating part of a process 300 for generating a sample of collision-free waypoints that satisfies all constraints of a set of constraints based on a description of a robot and a workcell in which the robot operates. The process 300 can be performed by a system that implements the robot path-generating techniques described in this specification, e.g., the system 100 of FIG. 1, programmed appropriately in accordance with this specification. Each waypoint of the sample can represent a collision-free joint configuration of the robot. Thus, in the following description, the terms collision-free joint configurations and collision-free waypoints are used interchangeably.

In the process 300, collision-free joint configurations of a robot are repeatedly randomly sampled. For each sampled collision-free joint configuration, it is determined whether the sampled collision-free joint configuration satisfies a set of constraints. The set of constraints can be based on physical constraints of the workcell in which the robot operates. The set of constraints can be based on physical constraints due to the structure of the robot. The set of constraints can be based on any suitable factors related to the context of the operation of the robot. The set of constraints can also be specified by the user, for example to define a working envelope of the robot that is allowed and considered safe for this robot parameter identification.

For example, the set of constraints can include a constraint that is defined such that a joint configuration satisfies the constraint if its mapping into the 6D cartesian coordinate space has a 3D position that is within a specified bounding box, as described with reference to FIG. 1. The set of constraints can include a constraint such that a joint configuration satisfies the constraint if its mapping into the 6D cartesian coordinate space has a 3D orientation with a particular axis of the 3D orientation being within a specified angle of a specified 3D vector, as described with reference to FIG. 1.

For each sampled collision-free joint configuration, if the sampled collision-free joint configuration does not satisfy the set of constraints, it is projected into the constraint manifold 302. The constraint manifold 302 can be a set of collision-free joint configurations that satisfy the set of constraints. For example, the constraint manifold 302 can be the set of all possible collision-free joint configurations that satisfy the set of constraints. If the projection of the sampled collision-free joint configuration is a joint configuration that satisfies the set of constraints, it is retained in the sample of collision-free waypoints. If the projection of the sampled collision-free joint configuration is not a joint configuration that is collision-free (e.g., projecting the collision-free joint configuration into the constraint manifold 302 causes the joint-configuration to no longer be collision-free), it is discarded from the sample of collision-free waypoints.

As an example, the sampled collision-free joint configuration 304 of FIG. 3 does not satisfy the set of constraints. Joint configuration 304 is therefore projected to the sampled collision-free joint configuration 306, which is included in the constraint manifold 302. Joint configuration 306 satisfies the set of constraints, so it is retained in the sample of collision-free waypoints.

For each sampled collision-free joint configuration, if the sampled collision-free joint configuration satisfies the set of constraints, it is not projected into the constraint manifold 302 and is retained in the sample of collision-free waypoints.

As an example, the sampled collision-free joint configuration 308 of FIG. 3 satisfies the set of constraints, as it is included in the constraint manifold 302. Joint configuration 308 therefore need not be projected to the constraint manifold 302 since it is already inside the constraint manifold and is retained in the sample of collision-free waypoints.

This process of sampling a collision-free joint configuration, determining whether it satisfies the set of constraints, and acting according to the determination as described above is repeated until a desired number of collision-free waypoints are retained in the sample of collision-free waypoints. The desired number of collision-free waypoints in the sample that satisfy all constraints in a set of constraints can be any suitable number, such as, for example, 100 waypoints.

FIG. 4 is an example result 400 of running a BFS algorithm on a subgraph of collision-free waypoints in order to enumerate all possible pruned graph versions of the subgraph. The BFS algorithm for which an example result is illustrated in FIG. 4 can be run by a subgraph generator that is used in a system that implements the robot-path generating techniques described in this specification, e.g., the subgraph generator 106 of the system 100 of FIG. 1, appropriately programmed in accordance with this specification. In particular, the subgraph generator that runs the BFS algorithm can run the BFS algorithm as part of the techniques employed by the subgraph generator to generate a plurality of candidate subgraphs, e.g., the plurality of candidate subgraphs 138 of FIG. 1, based on a plurality of reachable waypoints, e.g., the plurality of reachable waypoints 136 of FIG. 1, to be used by the system in generating a trajectory to be traversed by the robot.

The subgraph 402 is a subgraph of collision-free waypoints on which the BFS algorithm is run. The subgraph 402 includes five vertices labeled 0, 1, 2, 3, and 4. The five vertices are collision-free waypoints that satisfy all constraints in a set of constraints. Each of the collision-free waypoints of the subgraph 402 can represent a collision-free joint configuration of a robot (e.g., the robot for which the trajectory is to be generated by the system). Each vertex is connected to other vertices by edges. Each edge is illustrated as a line connecting two vertices. Each edge is an interpolation between the two joint configurations represented by the two waypoints that are the two vertices that the edge connects. An edge only connects two vertices if the interpolation between the two joint configurations represented by the two waypoints that are the two vertices does not result in either a collision or a violation of a set of constraints (e.g., a set of constraints imposed on the trajectory to be generated for the robot using the subgraph). Each edge is labeled with a number that indicates the length of the edge, i.e., the distance to be traversed by a robot in traversing between the two joint configurations represented by the two waypoints that are the two vertices that the edge connects. In some implementations, this distance can be the L₂ norm of the difference between two vectors that represent the two waypoints, where each of the waypoints is represented as a vector with the number of the degrees of freedom of the robot in the configuration corresponding to the waypoint as the vector length, as described with reference to FIG. 1.

The subgraph 402 can represent a trajectory to be traversed by a robot, e.g., the robot for which the trajectory is to be generated by the system. For example, the vertex labeled 0 can represent a starting joint configuration for the robot. The vertex labeled 1 can represent the joint configuration that the robot on the trajectory assumes after assuming the starting joint configuration and traversing the distance represented by the length of the edge connecting the vertex labeled 0 to the vertex labeled 1. The vertex labeled 2 can represent the joint configuration that the robot on the trajectory assumes after assuming the joint configuration represented by the vertex labeled 1 and traversing the distance represented by the length of the edge connecting the vertex labeled 1 and the vertex labeled 2, and so on.

The BFS algorithm enumerates all possible pruned graph versions of the subgraph 402 by eliminating vertices from the subgraph 402. In particular, each possible pruned graph version of the subgraph 402 is generated by eliminating a first vertex from the subgraph 402 and then, if the elimination of the first vertex results in a second vertex remaining in the subgraph with only one edge connecting it to another vertex in the subgraph, eliminating the second vertex from the subgraph 402.

For example, the pruned graph version 404 is generated by eliminating the vertex labeled 1 from the subgraph 402. The pruned graph version 406 is generated by eliminating the vertex labeled 2 from the subgraph 402. Upon elimination of the vertex labeled 2 from the subgraph 402, the vertex labeled 1 is a vertex with only one edge connecting it to another vertex in the subgraph 402. Therefore, the vertex labeled 1 is also eliminated from the subgraph 402 in generating the pruned graph version 406. The pruned graph version 408 is generated by eliminating the vertex labeled 4 from the subgraph 402.

An arrow connects the pruned graph version 404 and the pruned graph version 406 to represent the fact that the pruned graph version 406 can also be generated from the pruned graph version 404 by eliminating the vertex labeled 2 from the pruned graph version 404.

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

In this specification, a task is an operation to be performed by a tool. For brevity, when a robot has only one tool, a task can be described as an operation to be performed by the robot as a whole. Example tasks include welding, glue dispensing, part positioning, and surface sanding, to name just a few examples. Tasks are generally associated with a type that indicates the tool required to perform the task, as well as a position within a workcell at which the task will be performed.

In this specification, a motion plan is a data structure that provides information for executing an action, which can be a task, a cluster of tasks, or a transition. Motion plans can be fully constrained, meaning that all values for all controllable degrees of freedom for the robot are represented explicitly or implicitly; or underconstrained, meaning that some values for controllable degrees of freedom are unspecified. In some implementations, in order to actually perform an action corresponding to a motion plan, the motion plan must be fully constrained to include all necessary values for all controllable degrees of freedom for the robot. Thus, at some points in the planning processes described in this specification, some motion plans may be underconstrained, but by the time the motion plan is actually executed on a robot, the motion plan can be fully constrained. In some implementations, motion plans represent edges in a task graph between two configuration states for a single robot. Thus, generally there is one task graph per robot.

In this specification, a motion swept volume is a region of the space that is occupied by at least a portion of a robot or tool during the entire execution of a motion plan. The motion swept volume can be generated by collision geometry associated with the robot-tool system.

In this specification, a transition is a motion plan that describes a movement to be performed between a start point and an end point. The start point and end point can be represented by poses, locations in a coordinate system, or tasks to be performed. Transitions can be underconstrained by lacking one or more values of one or more respective controllable degrees of freedom (DOF) for a robot. Some transitions represent free motions. In this specification, a free motion is a transition in which none of the degrees of freedom are constrained. For example, a robot motion that simply moves from pose A to pose B without any restriction on how to move between these two poses is a free motion. During the planning process, the DOF variables for a free motion are eventually assigned values, and path planners can use any appropriate values for the motion that do not conflict with the physical constraints of the workcell.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining a plurality of collision-free waypoints that satisfy all of one or more constraints, wherein each waypoint represents a joint configuration of a robot;
generating a graph of the plurality of collision-free waypoints;
selecting a plurality of waypoints in the graph that are reachable from a starting waypoint within a maximum number of edges according to the graph;
performing one or more pruning processes on the plurality of waypoints in the graph to generate a plurality of candidate subgraphs that each satisfy one or more linear-time solvability checks;
computing a respective cost for each candidate subgraph of the plurality of candidate subgraphs, wherein the cost for each candidate subgraph is based on a measure of how informative the waypoints of the candidate subgraph are for solving for a plurality of robot parameters of the robot;
selecting a candidate subgraph based on the costs computed for the candidate subgraphs; and
performing a path solving process on the selected candidate subgraph to generate a path to be traversed by the robot in order to obtain data for solving for the plurality of robot parameters.

Embodiment 2 is the method of embodiment 1, wherein the cost for each candidate subgraph is based on a measure of a size of the candidate subgraph.

Embodiment 3 is the method of embodiment 2, wherein the cost for each candidate subgraph is a linear combination of the measure of the size of the candidate subgraph and the measure of how informative the waypoints of the candidate subgraph are for solving for a plurality of robot parameters of the robot.

Embodiment 4 is the method of any one of embodiments 1-3, wherein the one or more linear-time solvability checks include one or more of:
a condition that each vertex of the candidate subgraph has at least two edges if the candidate subgraph has more than two vertices;
a condition that a number of connected components in the candidate subgraph is equal to one; and
a condition that a number of cut vertices in the candidate subgraph is equal to zero.

Embodiment 5 is the method of any one of embodiments 1-4, wherein obtaining a plurality of collision-free waypoints that satisfy all constraints of a set of constraints, wherein each waypoint represents a joint configuration of a robot comprises:
projecting one or more collision-free waypoints into a constraint-satisfying set of waypoints.

Embodiment 6 is the method of any one of embodiments 1-5, further comprising:
generating an adjacency matrix based on the graph of the plurality of collision-free waypoints.

Embodiment 7 is the method of any one of embodiments 1-6, wherein performing one or more pruning processes on the plurality of waypoints in the graph to generate a plurality of candidate subgraphs that each satisfy one or more linear-time solvability checks comprises:
determining that each of the plurality of candidate subgraphs satisfy the one or more linear-time solvability checks based on an adjacency matrix of the candidate subgraph.

Embodiment 8 is the method of any one of embodiments 1-7, wherein performing one or more pruning processes on the plurality of waypoints in the graph to generate a plurality of candidate subgraphs that each satisfy one or more linear-time solvability checks comprises:
eliminating waypoints from the plurality of waypoints that have a minimum number of connections to other waypoints in the plurality of waypoints until a maximum number of waypoints remains in the plurality of waypoints.

Embodiment 9 is the method of any one of embodiments 2-8, wherein the measure of the size of the candidate subgraph is an extent to which the size of the candidate subgraph exceeds a minimum graph size.

Embodiment 10 is the method of any one of embodiments 1-9, wherein the measure of how informative the waypoints of the candidate subgraph are for solving for a plurality of robot parameters of the robot, is based on a condition number of a regressor matrix derived from the waypoints of the candidate subgraph.

Embodiment 11 is the method of any one of embodiments 1-10, wherein selecting a candidate subgraph based on the costs computed for the candidate subgraphs comprises selecting the candidate subgraph with a minimum cost.

Embodiment 12 is the method of embodiment 11, wherein selecting the candidate subgraph with the minimum cost comprises extracting a minimum component from a priority queue data structure, wherein the priority queue data structure is generated based on the candidate subgraphs and the computed costs.

Embodiment 13 is the method of any one of embodiments 1-12, wherein selecting a candidate subgraph based on the costs computed for the candidate subgraphs comprises:
determining whether there is a solution to the path solving process for the selected candidate subgraph; and
repeatedly selecting a candidate subgraph based on the costs computed for the candidate subgraphs until it is determined that there is a solution to the path solving process for the selected candidate subgraph.

Embodiment 14 is a system comprising one or more computers and one or more storage devices storing instructions that are operable, when executed by the one or more computers, to cause the one or more computers to perform the method of any one of embodiments 1-13.

Embodiment 15 is a computer storage medium encoded with a computer program, the program comprising instructions that are operable, when executed by data processing apparatus, to cause the data processing apparatus to perform the method of any one of embodiments 1-13.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

1. A computer-implemented method comprising:
obtaining a plurality of collision-free waypoints that satisfy all of one or more constraints, wherein each waypoint represents a joint configuration of a robot;
generating a graph of the plurality of collision-free waypoints;
selecting a plurality of waypoints in the graph that are reachable from a starting waypoint within a maximum number of edges according to the graph;
performing one or more pruning processes on the plurality of waypoints in the graph to generate a plurality of candidate subgraphs that each satisfy one or more linear-time solvability checks;
computing a respective cost for each candidate subgraph of the plurality of candidate subgraphs, wherein the cost for each candidate subgraph is based on a measure of how informative the waypoints of the candidate subgraph are for solving for a plurality of robot parameters of the robot;
selecting a candidate subgraph based on the costs computed for the candidate subgraphs; and
performing a path solving process on the selected candidate subgraph to generate a path to be traversed by the robot in order to obtain data for solving for the plurality of robot parameters.

2. The method of claim 1, wherein the cost for each candidate subgraph is based on a measure of a size of the candidate subgraph.

3. The method of claim 2, wherein the cost for each candidate subgraph is a linear combination of the measure of the size of the candidate subgraph and the measure of how informative the waypoints of the candidate subgraph are for solving for a plurality of robot parameters of the robot.

4. The method of claim 1, wherein the one or more linear-time solvability checks include one or more of:
a condition that each vertex of the candidate subgraph has at least two edges if the candidate subgraph has more than two vertices;
a condition that a number of connected components in the candidate subgraph is equal to one; and
a condition that a number of cut vertices in the candidate subgraph is equal to zero.

5. The method of claim 1, wherein obtaining a plurality of collision-free waypoints that satisfy all constraints of a set of constraints, wherein each waypoint represents a joint configuration of a robot comprises:
projecting one or more collision-free waypoints into a constraint-satisfying set of waypoints.

6. The method of claim 1, further comprising:
generating an adjacency matrix based on the graph of the plurality of collision-free waypoints.

7. The method of claim 1, wherein performing one or more pruning processes on the plurality of waypoints in the graph to generate a plurality of candidate subgraphs that each satisfy one or more linear-time solvability checks comprises:
determining that each of the plurality of candidate subgraphs satisfy the one or more linear-time solvability checks based on an adjacency matrix of the candidate subgraph.

8. The method of claim 1, wherein performing one or more pruning processes on the plurality of waypoints in the graph to generate a plurality of candidate subgraphs that each satisfy one or more linear-time solvability checks comprises:
eliminating waypoints from the plurality of waypoints that have a minimum number of connections to other waypoints in the plurality of waypoints until a maximum number of waypoints remains in the plurality of waypoints.

9. The method of claim 2, wherein the measure of the size of the candidate subgraph is an extent to which the size of the candidate subgraph exceeds a minimum graph size.

10. The method of claim 1, wherein the measure of how informative the waypoints of the candidate subgraph are for solving for a plurality of robot parameters of the robot, is based on a condition number of a regressor matrix derived from the waypoints of the candidate subgraph.

11. The method of claim 1, wherein selecting a candidate subgraph based on the costs computed for the candidate subgraphs comprises selecting the candidate subgraph with a minimum cost.

12. The method of claim 11, wherein selecting the candidate subgraph with the minimum cost comprises extracting a minimum component from a priority queue data structure, wherein the priority queue data structure is generated based on the candidate subgraphs and the computed costs.

13. The method of claim 1, wherein selecting a candidate subgraph based on the costs computed for the candidate subgraphs comprises:
determining whether there is a solution to the path solving process for the selected candidate subgraph; and
repeatedly selecting a candidate subgraph based on the costs computed for the candidate subgraphs until it is determined that there is a solution to the path solving process for the selected candidate subgraph.

14. A system comprising one or more computers and one or more storage devices on which are stored instructions that are operable, when executed by the one or more computers, to cause the one or more computers to perform operations comprising:
obtaining a plurality of collision-free waypoints that satisfy all of one or more constraints, wherein each waypoint represents a joint configuration of a robot;
generating a graph of the plurality of collision-free waypoints;
selecting a plurality of waypoints in the graph that are reachable from a starting waypoint within a maximum number of edges according to the graph;
performing one or more pruning processes on the plurality of waypoints in the graph to generate a plurality of candidate subgraphs that each satisfy one or more linear-time solvability checks;
computing a respective cost for each candidate subgraph of the plurality of candidate subgraphs, wherein the cost for each candidate subgraph is based on a measure of how informative the waypoints of the candidate subgraph are for solving for a plurality of robot parameters of the robot;
selecting a candidate subgraph based on the costs computed for the candidate subgraphs; and
performing a path solving process on the selected candidate subgraph to generate a path to be traversed by the robot in order to obtain data for solving for the plurality of robot parameters.

15. The system of claim 14, wherein the cost for each candidate subgraph is based on a measure of a size of the candidate subgraph.

16. The system of claim 14, wherein the one or more linear-time solvability checks include one or more of:
a condition that each vertex of the candidate subgraph has at least two edges if the candidate subgraph has more than two vertices;
a condition that a number of connected components in the candidate subgraph is equal to one; and
a condition that a number of cut vertices in the candidate subgraph is equal to zero.

17. The system of claim 14, wherein performing one or more pruning processes on the plurality of waypoints in the graph to generate a plurality of candidate subgraphs that each satisfy one or more linear-time solvability checks comprises:
Determining that each of the plurality of candidate subgraphs satisfy the one or more linear-time solvability checks based on an adjacency matrix of the candidate subgraph.

18. One or more non-transitory computer-readable storage media encoded with computer program instructions that when executed by one or more computers cause the one or more computers to perform operations comprising:
obtaining a plurality of collision-free waypoints that satisfy all of one or more constraints, wherein each waypoint represents a joint configuration of a robot;
generating a graph of the plurality of collision-free waypoints;
selecting a plurality of waypoints in the graph that are reachable from a starting waypoint within a maximum number of edges according to the graph;
performing one or more pruning processes on the plurality of waypoints in the graph to generate a plurality of candidate subgraphs that each satisfy one or more linear-time solvability checks;
computing a respective cost for each candidate subgraph of the plurality of candidate subgraphs, wherein the cost for each candidate subgraph is based on a measure of how informative the waypoints of the candidate subgraph are for solving for a plurality of robot parameters of the robot;
selecting a candidate subgraph based on the costs computed for the candidate subgraphs; and
performing a path solving process on the selected candidate subgraph to generate a path to be traversed by the robot in order to obtain data for solving for the plurality of robot parameters.

19. The one or more non-transitory computer-readable storage media of claim 18, wherein the one or more linear-time solvability checks include one or more of:
a condition that each vertex of the candidate subgraph has at least two edges if the candidate subgraph has more than two vertices;
a condition that a number of connected components in the candidate subgraph is equal to one; and
a condition that a number of cut vertices in the candidate subgraph is equal to zero.

20. The one or more non-transitory computer-readable storage media of claim 18, wherein performing one or more pruning processes on the plurality of waypoints in the graph to generate a plurality of candidate subgraphs that each satisfy one or more linear-time solvability checks comprises:
determining that each of the plurality of candidate subgraphs satisfy the one or more linear-time solvability checks based on an adjacency matrix of the candidate subgraph.
